(19) United States
(12) Patent Application Publication
(10) Pub. No.: US 2022/0195962 A1
(43) Pub. Date: Jun. 23, 2022

(54) SYSTEMS AND METHODS FOR EXPANDING AN OPERATING SPEED RANGE OF A HIGH SPEED FLIGHT VEHICLE

(71) Applicant: The Boeing Company, Chicago, IL (US)

(72) Inventors: Richard S. Dyer, Maryland Heights, MO (US); Matthew J. Roode, Webster Groves, MO (US); Kevin G. Bowcutt, Aliso Viejo, CA (US); Timothy H. Franklin, Ballwin, MO (US); Joseph S. Silkey, Lake Saint Louis, MO (US)

(73) Assignee: The Boeing Company, Chicago, IL (US)

(21) Appl. No.: 17/539,719

(22) Filed: Dec. 1, 2021

Related U.S. Application Data
(60) Provisional application No. 63/127,304, filed on Dec. 18, 2020.

(51) Int. Cl. F02K 3/06; B64D 33/02; F02K 3/075; F02K 3/105; F02K 1/09; F02K 1/12

(52) U.S. Cl. CPC F02K 3/06; B64D 33/02; F02K 3/075; F02K 3/105; F02K 1/09; F05D 2220/80; B64D 2033/026; B64D 2033/024; F05D 2260/201; F05D 2260/213; F05D 2220/323; F02K 1/1253

(57) ABSTRACT

Systems and methods for expanding an operating speed range of a high speed flight vehicle include providing an engine with an inlet air duct, and positioning a heat exchanger in the inlet air duct to cool at least a portion of duct air flow associated with an engine core. Additionally or alternatively, a nozzle assembly includes a cowl fluidly communicating with the engine and having a cowl internal surface defining a cowl orifice, and a plug defines a primary thrust surface. The plug is supported relative to the cowl so that a portion of the primary thrust surface is disposed within the cowl orifice to define a throat therebetween. An actuator is coupled to at least one of the cowl or the plug, and is configured to generate relative movement between the cowl and the plug, thereby to modify the throat.

### CROSS-REFERENCE TO RELATED APPLICATIONS

This application claims priority to, and the benefit of, U.S. Provisional Patent Application No. 63/127,304 filed Dec. 18, 2020, which is hereby incorporated by reference in its entirety.

### FIELD

The present disclosure generally relates to high speed flight vehicles and, more specifically, to systems and methods for expanding operating ranges of high speed flight vehicles.

### BACKGROUND

Operating conditions at high flight speeds present various challenges to flight vehicle design. For example, a gas turbine engine of a flight vehicle traveling through atmosphere at speeds greater than Mach 3, and more particularly at hypersonic speeds greater than Mach 5, may experience localized temperatures that reach or exceed a material temperature limit. In conventional flight vehicle design, the engine is throttled back as the temperature nears the material temperature limit, thereby to avoid exceeding the material temperature limit. When excessive throttling back is needed due to high temperatures, the engine no longer accelerates the flight vehicle, thereby limiting a top operating speed of the flight vehicle. Additionally, nozzle design may impose limits on the operating range of the flight vehicle. For example, a nozzle configured for speeds greater than Mach 3 may induce over-expansion drag at lower speeds, or may otherwise fail to provide propulsive efficiency across a range of operating speeds of the flight vehicle.

### SUMMARY

In accordance with one aspect of the present disclosure, a turbine engine for a high speed flight vehicle comprises an inlet air duct having an upstream end for receiving ambient air and a downstream end, the inlet air duct directing a duct air flow from the upstream end to the downstream end, and a fan disposed in the inlet air duct. An engine core is disposed in the inlet air duct and operably coupled to the fan, the engine core being disposed downstream of the fan and including a core housing, through which passes a core air flow portion of the duct air flow. An afterburner is disposed in the inlet air duct and downstream of the engine core, and a heat exchanger disposed in the inlet air duct.

In accordance with another aspect of the present disclosure, a nozzle assembly is provided for a flight vehicle having an engine. The nozzle assembly comprises a cowl in fluidic communication with the engine, the cowl including a cowl internal surface defining a cowl orifice, and a plug defining a primary thrust surface, wherein the plug is supported relative to the cowl so that a portion of the primary thrust surface is disposed within the cowl orifice, wherein the primary thrust surface of the plug and the cowl internal surface are spaced to define a throat. An actuator is coupled to at least one of the cowl or the plug, and is configured to generate relative movement between the cowl and the plug, thereby to modify the throat.

In accordance with a further aspect of the present disclosure, a method is provided of controlling thrust to a flight vehicle having an engine and an airframe. The method comprises providing a nozzle assembly comprising a cowl in fluidic communication with the engine, the cowl including a cowl internal surface defining a cowl orifice, and a plug defining a primary thrust surface, wherein the plug is supported by the airframe relative to the cowl so that a portion of the primary thrust surface is disposed within the cowl orifice, wherein the primary thrust surface of the plug and the cowl internal surface are spaced to define a throat. The method further comprises generating relative movement between the cowl and the plug, thereby to modify the throat.

The features, functions, and advantages that have been discussed can be achieved independently in various examples or may be combined in yet other examples further details of which can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and advantages thereof, will best be understood by reference to the following detailed description of illustrative examples of the present disclosure when read in conjunction with the accompanying drawings, wherein:

FIG. 1 is a perspective view of a high speed flight vehicle having an integrated cooling and power generation system according to the present disclosure.

FIG. 2 is a schematic illustration of a turbine engine with air cooling across an entire air flow.

FIG. 3 is a schematic illustration of a turbine engine with air cooling across a core air flow.

FIG. 4 is a schematic illustration of an alternative example of a turbine engine with air cooling across a core air flow.

FIG. 5 is a schematic illustration of a further example of a turbine engine with air cooling across a core air flow.

FIG. 6 is a schematic illustration of a turbine engine with spot cooling in an engine core and afterburner liner.

FIG. 7 is a perspective view of a tail portion of the high speed flight vehicle of FIG. 1.

FIG. 8 is a side elevation view, in partial cross section, of the tail portion of the high speed flight vehicle of FIG. 7, with a cowl and a primary thrust surface in first positions relative to each other.

FIG. 9 is a side elevation view, in partial cross-section, of the tail portion of the high speed flight vehicle of FIG. 7, with the cowl and primary thrust surface in second positions relative to each other.

FIG. 10 is a side elevation view of the tail portion of the high speed flight vehicle of FIG. 7, showing a primary thrust surface that translates parallel to a longitudinal axis of the flight vehicle.

FIG. 11 is a side elevation view of the tail portion of the high speed flight vehicle of FIG. 7, showing a primary thrust surface that translates in a direction perpendicular to a longitudinal axis of the flight vehicle.

FIG. 12 is a side elevation view of the tail portion of the high speed flight vehicle of FIG. 7, showing a primary thrust surface that rotates relative to an airframe of the flight vehicle.

FIG. 13 is a side elevation view of the tail portion of the high speed flight vehicle of FIG. 7, showing a primary thrust surface that translates in a direction that is at an angle relative to the longitudinal axis of the flight vehicle.

FIG. 14 is a schematic end view diagram of a first example of a shape of a thrust surface.

FIG. 15 is a schematic end view diagram of a second example of a shape of a thrust surface.

FIG. 16 is a schematic end view diagram of a third example of a shape of a thrust surface.

FIG. 17 is schematic side view diagram of a first example of a thrust surface longitudinal profile.

FIG. 18 is schematic side view diagram of a second example of a thrust surface longitudinal profile.

FIG. 19 is schematic side view diagram of a third example of a thrust surface longitudinal profile.

FIG. 20 is a side elevation view, in partial cross-section, of the tail portion of the high speed flight vehicle of FIG. 7, showing a first example of a nozzle cooling system.

FIG. 21 is a side elevation view, in partial cross-section, of the tail portion of the high speed flight vehicle of FIG. 7, showing a second example of a nozzle cooling system.

FIGS. 22-24 are schematic plan view diagrams showing examples of perforation profiles formed in a plug wall of the nozzle assembly.

FIG. 25 is a side elevation view, in partial cross-section, of the tail portion of the high speed flight vehicle of FIG. 7, showing a low flow rate of coolant to the nozzle assembly.

FIG. 26 is a side elevation view, in partial cross-section, of the tail portion of the high speed flight vehicle of FIG. 7, showing a high flow rate of coolant to the nozzle assembly.

### DETAILED DESCRIPTION

The figures and the following description illustrate specific examples of the claimed subject matter. It will thus be appreciated that those skilled in the art will be able to devise various arrangements that, although not explicitly described or shown herein, embody the principles of the examples and are included within the scope of the examples. Furthermore, any examples described herein are intended to aid in understanding the principles of construction, operation, or other features of the disclosed subject matter, and are to be construed as being without limitation to such specifically recited examples and conditions. As a result, the inventive concept(s) is not limited to the specific examples described below, but by the claims and their equivalents.

Examples of a turbine engine for a high speed flight vehicle described herein provide cooling to permit operation of the flight vehicle at higher speeds. A heat exchanger is used to cool air passing through an inlet duct, a core housing, specific components of an engine core, and/or a liner of the duct adjacent an afterburner, thereby preventing the temperature of the components from reaching thermal limits. As a result, the turbine engine may continue operation without throttle reduction, thereby increasing the upper end of the range at which the flight vehicle travels.

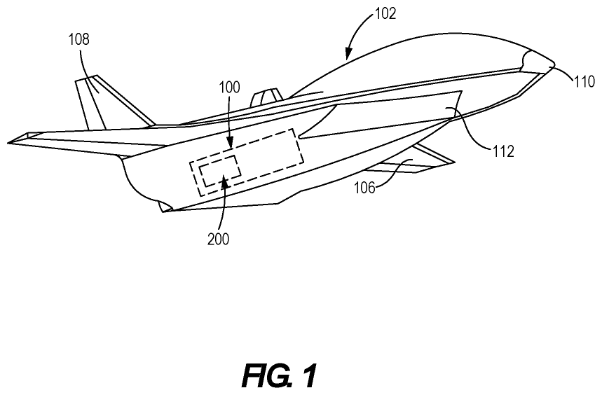

FIG. 1 illustrates an example of a high speed flight vehicle 102. The flight vehicle 102 may be operated piloted or unpiloted, as desired. The flight vehicle 102 is just one configuration of a flight vehicle capable of traveling at a speed of at least Mach 3, and other configurations, not shown, may be implemented as desired. For example, the flight vehicle 102 may have a different shape, size, aspect ratio, etc., as desired. Thus, the flight vehicle 102 is merely shown in a particular configuration for purposes of discussion.

In this example, the flight vehicle 102 includes a turbine engine 100, a wing 106, a tail 108, and a nose cap 110. The turbine engine 100 is the primary source of propulsion for the flight vehicle 102. During operation of the flight vehicle 102 above Mach 3, or in hypersonic flight (e.g., the flight vehicle 102 moves at hypersonic speeds of Mach 5 and above), the embodiments described herein prevent portions of the turbine engine 100 from being heated to temperatures that are near or exceed thermal limits for the materials used in the turbine engine 100.

In the examples illustrated at FIGS. 2-6, the airflow and/or specific components or areas of the turbine engine 100 are cooled to reduced temperatures below the thermal limit, thereby permitting the flight vehicle 102 to operate at higher speeds. The turbine engine 100 illustrated at FIG. 2, for example, includes an inlet air duct 112 having an upstream end 114 for receiving ambient air and a downstream end 116. The inlet air duct 112 directs a duct air flow 118 from the upstream end 114 to the downstream end 116. As used herein, the duct air flow 118 includes air that flows across an entire cross-sectional area of the inlet air duct 112. The turbine engine 100 includes a fan 120, which is disposed in the inlet air duct 112 and draws air into the inlet air duct 112.

The turbine engine 100 further includes an engine core 122 for producing propulsion from jet core efflux. The engine core 122 is disposed in a center portion of the inlet air duct 112, is operably coupled to the fan 120, and is located downstream of the fan 120. The engine core 122 includes a core housing 124, which divides the duct air flow 118 into a core air flow 126, which passes through the core housing 124, and a bypass air flow 128, which passes around the core housing 124. An afterburner 130 is disposed in the inlet air duct 112 and downstream of the engine core 122 to selectively provide additional thrust to the flight vehicle 102. A portion of the inlet air duct 112 surrounding and downstream of the afterburner 130 includes an afterburner liner 132 for thermal protection of a downstream end of the inlet air duct 112.

The turbine engine 100 includes cooling to mitigate high temperatures associated with operation of the flight vehicle 102. In the example illustrated at FIGS. 2-6, a heat exchanger 140 is used to provide cooling. The heat exchanger 140 includes one or more conduits 142 that are in fluidic communication with a heat sink fluid source 144. Heat sink fluid passing through the conduit(s) 142 absorbs heat from the environment surrounding the conduit(s), thereby reducing temperature. The heat sink fluid source 144 may be an ancillary source of fluid on the flight vehicle 102, a dedicated thermal management system, a power generation system, or a sub-system that requires heat for operation, or any combination thereof. For example, the heat sink fluid may be fuel, water, air, or any other fluid used on or available to the flight vehicle. In some examples, the heat sink fluid may be a supercritical fluid, such as supercritical carbon dioxide, which provides efficient heat transfer while reducing the size and weight of components used in the heat exchanger 140.

The heat exchanger 140 may be located in different positions within the turbine engine 100, and/or may be provided in different sizes, to provide the desired cooling effect. In FIG. 2, for example, the heat exchanger 140 is positioned upstream of the fan 120. Additionally, the heat exchanger 140 is configured to absorb heat from an entirety of the duct air flow 118. Accordingly, as shown in FIG. 2, the heat exchanger 140 extends across an entire cross-section of the inlet air duct 112, thereby reducing temperature across the entire duct air flow 118. Locating the heat exchanger 140 upstream of the fan 120 exposes the heat exchanger to lower temperatures and pressures than those present further downstream, reducing material and other design considerations for the heat exchanger 140. This location of the heat exchanger 140 also provides cooling prior to compression of the air flow, thereby increasing the thermodynamic advantage effected by the heat exchanger 140.

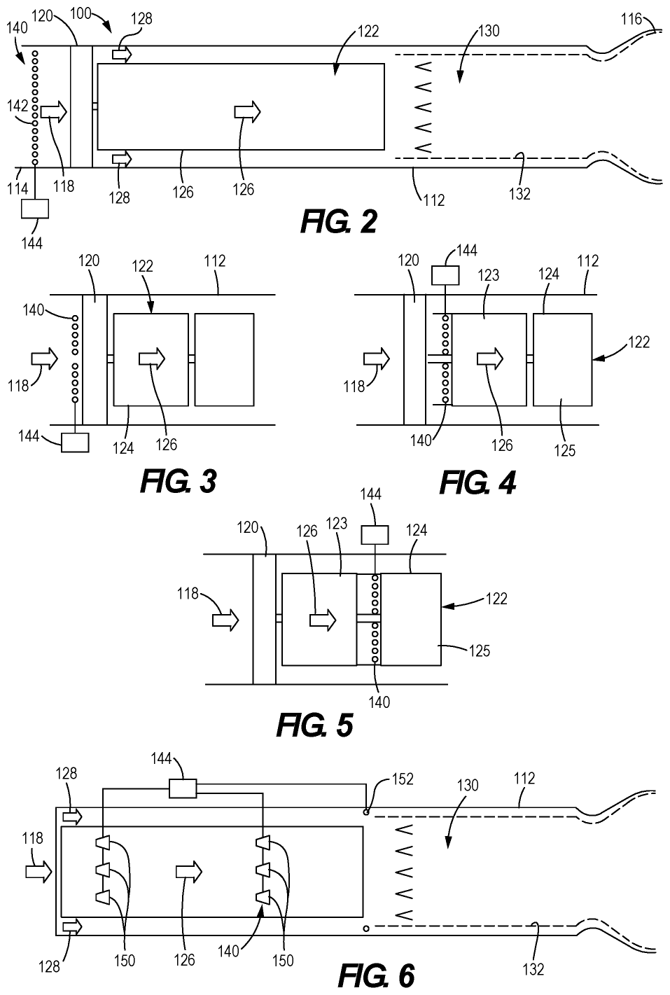

FIGS. 3-5 illustrates examples in which the heat exchanger 140 cools only a portion of the duct air flow 118. In the example of FIG. 3, the heat exchanger 140 is positioned upstream of the fan, similar to the above example. Unlike in the example illustrated in FIG. 2, however, the heat exchanger 140 shown in FIG. 3 extends across only a central portion of the inlet air duct 112. Specifically, the heat exchanger 140 is positions and sized to extend across an area that corresponds to a cross-sectional area of the core housing 124. Consequently, the heat exchanger 140 extracts heat primarily from a portion of the duct air flow 118 that ultimately will pass through the engine core 122 as the core air flow 126. In this example, the heat exchanger 140 is still located upstream of the fan 120, thereby offering the same heat exchanger design considerations and thermodynamic advantage as the previous example. By covering a smaller area, however, the weight of the heat exchanger 140 is reduced while still cooling the portion of the duct air flow 118 that will see the greatest temperature increase further downstream.

FIG. 4 illustrates an alternative example in which the heat exchanger 140 is positioned between the fan 120 and the engine core 122. In this example, the engine core 122 includes a low pressure compressor 123 and a high pressure compressor 125. The heat exchanger 140 is disposed within the core housing 124 and upstream of the low pressure compressor 123, and therefore is configured to absorb heat only from the core air flow 126. The temperature and density of air at this location is greater than upstream of the fan 120 which permits the heat exchanger 140 to be more compact, thereby reducing the weight of the heat exchanger. The thermodynamic advantage of cooling at this location, however, will be reduced, and positioning the heat exchanger 140 between the fan 120 and the low pressure compressor 123 may require the shaft connecting these components to be lengthened, thereby potentially impacting turbomachinery design.

FIG. 5 illustrates a further example in which the heat exchanger 140 is disposed in the core housing 124, and therefore is configured to absorb heat only from the core air flow 126 portion of the duct air flow 118. In this example, the heat exchanger 140 is located between the low pressure compressor 123 and the high pressure compressor 125. At this location, the temperature and density of the air is even greater than the heat exchanger location shown in FIG. 4, thereby allowing the heat exchanger to be even more compact and therefore have less weight. The thermodynamic advantage of cooling at this location, however, is further reduced, and again may require the shaft to be lengthened, thereby impacting turbomachinery design.

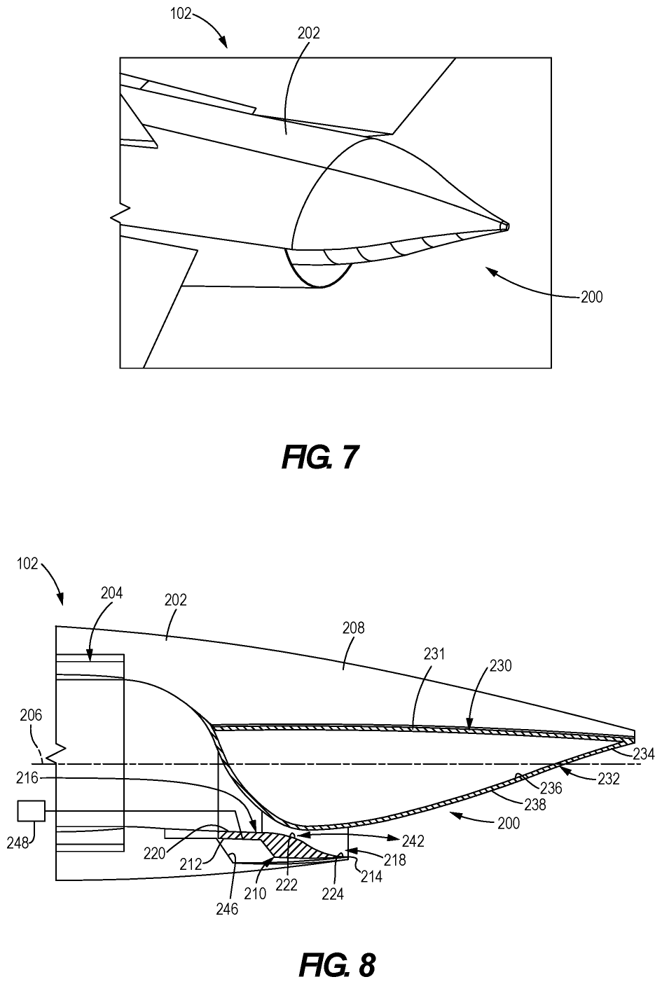

FIG. 6 illustrates examples of targeted cooling of specific locations of the turbine engine 100. The heat exchanger 140 of FIG. 6 includes one or more spot-cooling heat exchangers 150. Each spot-cooling heat exchanger 150 is in fluidic communication with the heat sink fluid source 144, and is configured to cool temperature sensitive areas or components of the turbine engine 100. For example, the spot-cooling heat exchanger 150 may be positioned to cool actuators, sensors, controllers, pumps, lubrication systems, or other accessories having more limited operating temperatures than the rest of the turbine engine 100.

Additionally, FIG. 6 illustrates targeted cooling at and downstream of the afterburner 130. When traveling at higher speeds, such as above Mach 3, the bypass air flow 128 reaches higher temperatures, thereby reducing the cooling capacity of the bypass air flow 128 to cool structure and components located downstream of the engine core 122. The afterburner liner 132 in particular is susceptible to temperatures levels that exceed thermal limits. FIG. 6 illustrates a liner cooler 152 configured to cool the afterburner liner 132. The liner cooler 152 is positioned upstream of and in longitudinal alignment with the afterburner liner 132. The liner cooler 152 is in fluidic communication with the heat sink fluid source 144, thereby absorbing heat from the bypass air flow 128. In the illustrated embodiment, the liner cooler 152 is located adjacent an interior surface of the inlet air duct 112, and therefore has a generally annular shape.

In additional examples illustrated in FIGS. 7-26, the flight vehicle 102 includes a nozzle assembly 200 that is configured to expand the operating speed range of the flight vehicle 102. The nozzle assembly 200 includes an expansion surface that permits greater support strength and interfacing with sub-systems and/or other components provided on the flight vehicle 102, the ability to adjust the shape and size of a nozzle orifice to maximize propulsive efficiency across a range of operating speeds, and a nozzle cooling system that reduces temperature at the nozzle while also influencing exhaust plume shape and resulting thrust generated by the propulsion system.

As best shown in FIGS. 7-9, the nozzle assembly 200 is shown coupled to an airframe 202 of the flight vehicle 102. The flight vehicle 102 includes an engine 204, and the nozzle assembly 200 is disposed downstream of and in fluid communication with the engine 204. The nozzle assembly 200 includes a cowl 210 having a cowl neck 212 at an upstream end and a cowl outlet 214 at a downstream end. The cowl 210 further includes a cowl internal surface 216 which defines a cowl orifice 218. In the examples disclosed herein, the cowl 210 has an arcuate shape. That is, when viewed along a longitudinal axis 206 of the flight vehicle I 02, the cowl 210 extends partially around the longitudinal axis 206. As used herein, the term “arcuate shape” means that the overall profile of the cowl 210 extends around an axis, and is intended to cover cowls that have curvilinear sections, rectilinear sections, or combinations thereof. The cowl internal surface 216 includes a cowl surface inlet section 220, a cowl surface transition section 222, and a cowl surface outlet section 224. The cowl surface inlet section 220 has a first radius RI and the cowl surface outlet section 224 has a second radius R2, which is greater than the first radius RI. The cowl surface transition section 222 has a radius that gradually increases, at a constant or variable rate, from the first radius RI to the second radius R2.

With continued reference to FIGS. 7-9, the nozzle assembly 200 further includes a plug 230, which defines a primary thrust surface 232 for the flight vehicle 102. The plug 230 is supported from the airframe 202 in cantilevered fashion. That is, the airframe 202 includes a tail section 208 at a rear of the flight vehicle 102, and the plug 230 includes a plug base 231 that is coupled to and depends from the tail section 208 of the airframe 202. In the illustrated examples, the plug base 231 extends around a periphery of the primary thrust surface 232 to permit secure attachment of the plug 230 to the airframe 202, while permitting operable coupling of the plug 230 to other systems and components provided on the flight vehicle 102. The plug 230 includes a plug wall 234 having a plug wall interior surface 236 and a plug wall exterior surface 238. The plug wall exterior surface 238 defines the primary thrust surface 232.

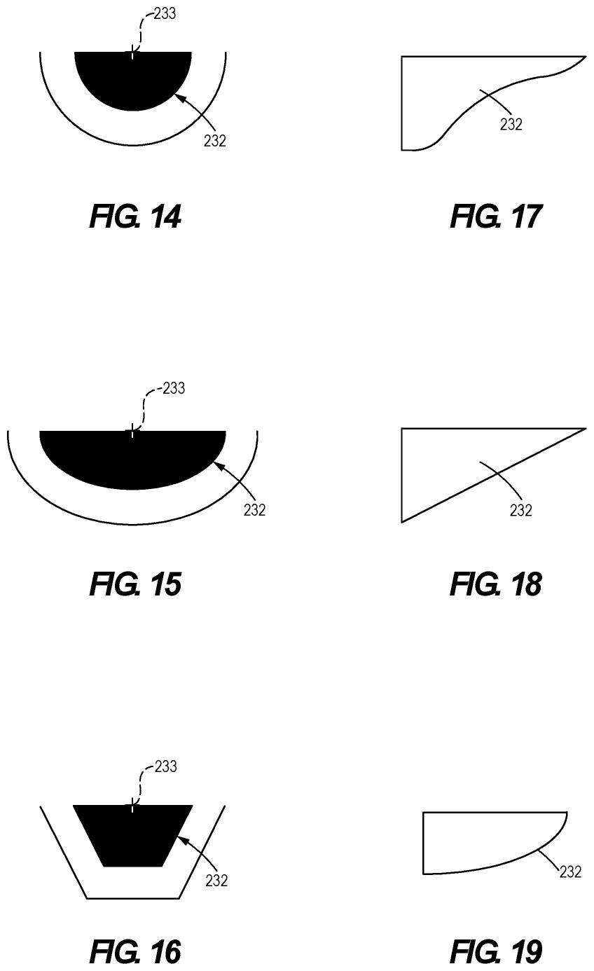

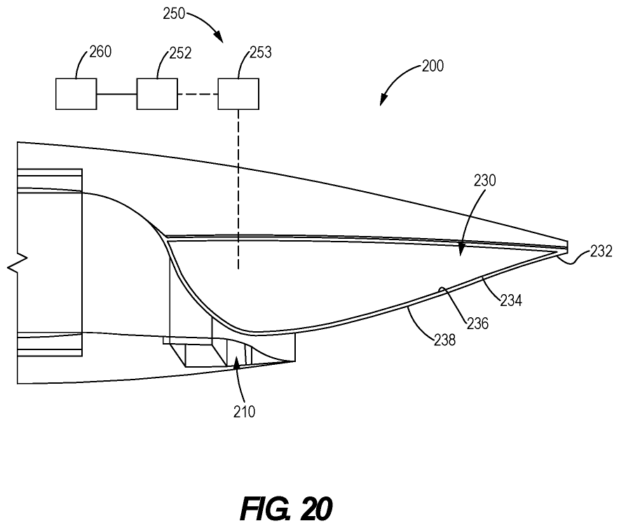

As shown in FIGS. 7-9 and 14-15, the thrust surface 232 is partially axi-symmetric. That is, when viewed from a downstream end of the plug 230, the thrust surface 232 is symmetrical at least partially about a longitudinal axis 233 of the plug 230. FIGS. 14 and 15 show examples of the thrust surface 232 having partial ellipsoid shapes. FIG. 16 illustrates a thrust surface 232 having a partial prism shape. Additionally, the longitudinal profile of the thrust surface 232 may be provided in different shapes to optimize thrust for a particular speed of the flight vehicle 102. In FIG. 17, the longitudinal profile of the thrust surface 232 is concave, which is advantageous for high speeds, such as hypersonic speeds. In FIG. 19, the longitudinal profile of the thrust surface 232 is convex, which is advantageous for subsonic and transonic speeds. FIG. 18 illustrates a longitudinal profiles of the thrust surface 232 that is linear, which is advantageous for speeds between subsonic/transonic and hypersonic speeds.

The plug 230 is positioned relative to the cowl 210 so that a portion of the primary thrust surface 232 is disposed within the cowl orifice 218. The primary thrust surface 232 and the cowl internal surface 216 are spaced to define therebetween a throat 242. The area of the throat 242, as well as the shapes of the primary thrust surface 232 and cowl internal surface 216, influence the direction and magnitude of thrust produced by the nozzle assembly 200.

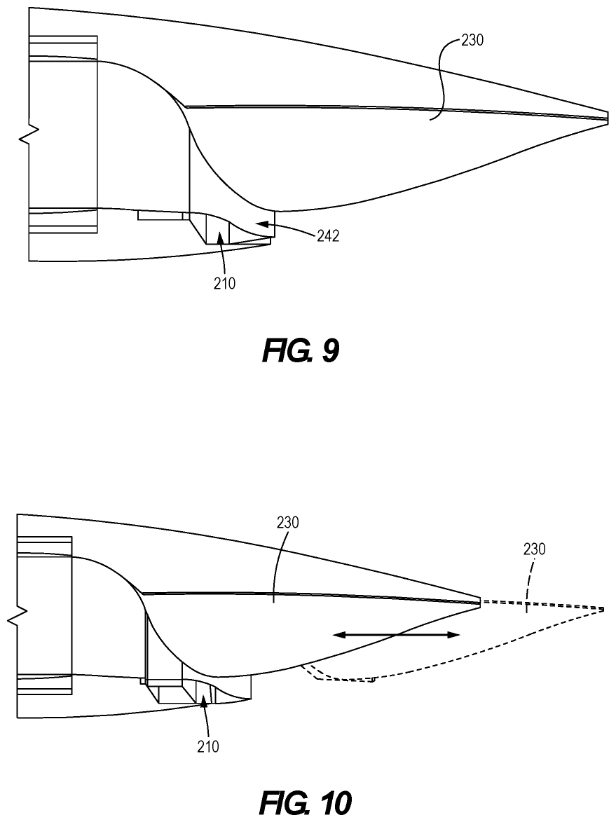

The cowl 210 and plug 230 are movable relative to each other, thereby to optimize thrust for a given speed of the flight vehicle 102. In the embodiment shown in FIGS. 7-9, the plug 230 is stationary while the cowl 210 is supported to translate in a direction parallel to the longitudinal axis 206 of the flight vehicle 102. More specifically, the cowl neck 212 is sized to be received in a slot 246 defined by the airframe 202. A cowl actuator 248 is operably coupled to the cowl 210 and configured to move the cowl 210 between a rearward position (FIG. 8) and a forward position (FIG. 9).

Relative movement between the cowl 210 and the plug 230 will change the thrust characteristics produced by the nozzle assembly 200. For example, regions of the cowl 210 and plug 230 that are nearest each other will form the throat 242. These regions will change as the cowl 210 and plug 230 move relative to each other. Accordingly, the respective contours of the cowl 210 and plug 230 will influence the size, location, angle, and cross-sectional area of the throat 242, thereby impacting thrust characteristics. For example, the cross-sectional area of the throat 242 is a primary control for the propulsion system. Throat location and angle also affect flow for the rest of the nozzle assembly 200, thereby affecting thrust efficiency. Still further, in some examples the contours of the cowl 210 and plug 230 influence the location of the throat 242, which affects the amount of internal expansion of the nozzle assembly 200. Control over the amount of internal expansion is a design factor used to produce high nozzle efficiency over a broad range of Mach numbers. For example, low internal expansion is advantageous subsonic and transonic flight speeds, while high internal expansion is advantageous for supersonic and hypersonic speeds. Accordingly, the ability to produce relative movement between the cowl 210 and the plug 230 allows the nozzle assembly 200 to optimize throat size, location, angle, and cross-sectional area for a particular flight speed, thereby expanding the speed range of the flight vehicle 102.

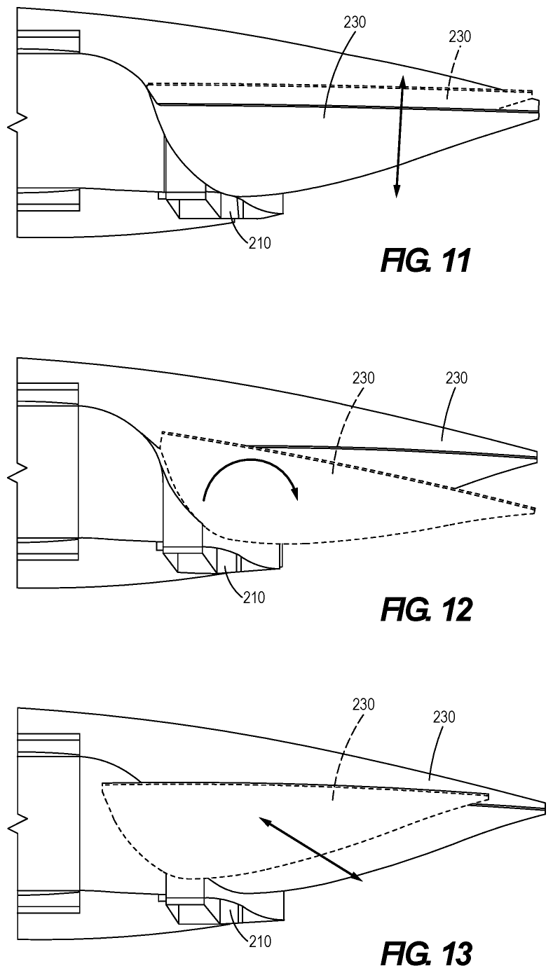

While the examples of FIGS. 7-9 show a stationary plug 230 and a movable cowl 210 that can translate in a direction parallel to the longitudinal axis 206, in other examples the cowl 210 is stationary and the plug 230 is movable, as shown in FIG. 10. Still further, both the cowl 210 and plug 230 may be movable. Additionally or alternatively, the cowl 210 and/or plug 230 may execute motions other than translation in a direction parallel to the longitudinal axis 206 to achieve relative movement of the cowl 210 and plug 230. FIG. 11 illustrates a plug 230 that is movable in a direction that is perpendicular to the longitudinal axis 206, while the cowl 210 is stationary. FIG. 12 illustrates a plug 230 that is rotatable relative to a stationary cowl 210. FIG. 13 illustrates a plug 230 that translates in a direction that is at an angle relative to the longitudinal axis 206.

In some examples, the nozzle assembly 200 includes a nozzle cooling system 250 that primarily reduces temperature at the nozzle assembly 200. Additionally, some examples of the nozzle cooling system 250 also influence a shape of the exhaust plume, thereby altering characteristics of the thrust generated by the nozzle assembly 200.

More specifically, the nozzle cooling system 250 includes a coolant source 252 that is thermally coupled to the primary thrust surface 232. The coolant source 252 may be ambient or bypass air, fluid from a thermal management system provided on the flight vehicle 102, or fluid from any other sub-system provided on the flight vehicle. For example, the coolant may be fuel, water, air, or any other fluid used on or available to the flight vehicle. In some examples, the coolant may be a supercritical fluid, such as supercritical carbon dioxide.

In the example shown in FIG. 20, coolant from the coolant source 252 is contained within the plug 230. In this example, the plug wall 234 is impervious, and the coolant source 252 is in fluidic communication with the plug wall interior surface 236. A coolant regulator 253, such as a pump or valve, controls flow of coolant from the coolant source 252 to the plug 230. As coolant flows to the plug 230, it cools the plug wall interior surface 236, which in tum cools the plug wall exterior surface 238 via conduction. Heated coolant can be recycled by to the coolant source 252 or other destination, or discharged from the flight vehicle 102.

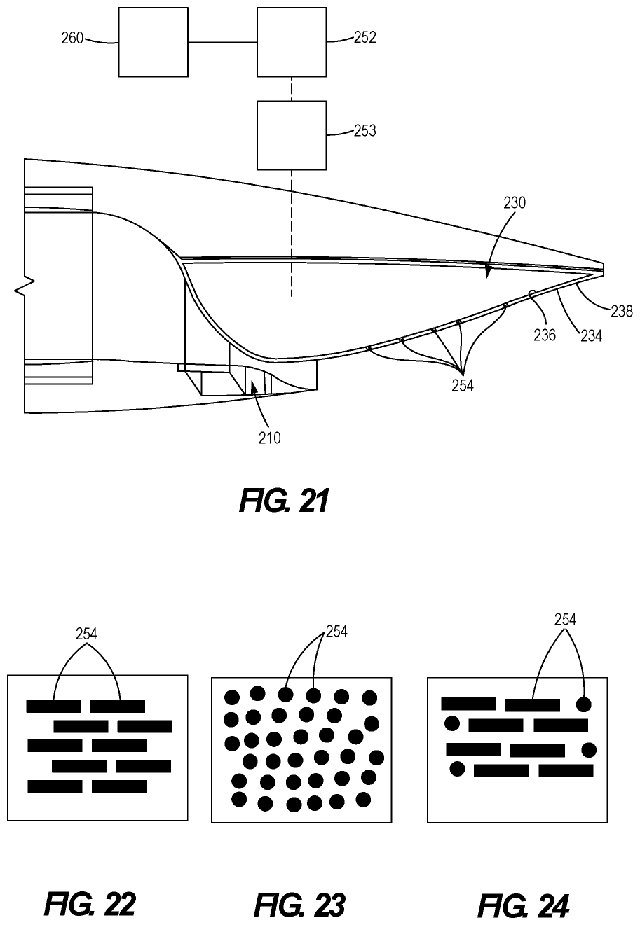

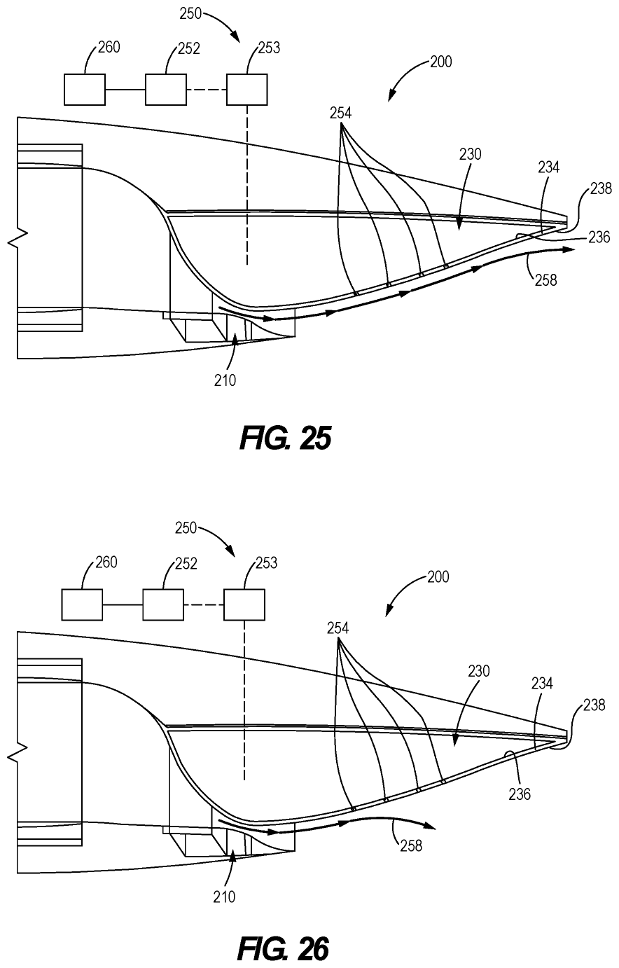

In the examples illustrated in FIGS. 21-24, coolant from the coolant source 252 passes through the plug wall 234 to directly cool the plug wall exterior surface 238. In these examples, the plug wall 234 includes perforations 254 extending from the plug wall interior surface 236 to the plug wall exterior surface 238. The perforations 254 may be provided in a variety of profile shapes and distribution patterns, which will effect the amount and location of cooling and the coolant flow rate. For example, if plug materials are used that are rated for sufficiently high temperatures, and/or engine exhaust flows are sufficiently cool, fewer perforations, smaller sized perforations, and/or a lower coolant flow rate may be used, reducing a weight of the nozzle cooling system 250. FIG. 22 illustrates perforations 254 having rectilinear profiles, while FIG. 23 illustrates perforations 254 having curvilinear profiles. In FIG. 24, the perforations 254 have both rectilinear and curvilinear profiles. Without wishing to be bound by theory, perforations 254 having curvilinear profiles may better align coolant flow to the plug wall exterior surface 238. The coolant regulator 253 selectively controls flow of coolant from the coolant source 252 to the plug wall interior surface 236. From the plug wall interior surface 236, coolant flows through the perforations 254 to form a film on the plug wall exterior surface 238. The coolant absorbs heat from both the plug wall exterior surface 238 and the exhaust gas, and may be discharged from the tail of the flight vehicle 102.

FIGS. 25 and 26 illustrate how the flow rate of the coolant can be adjusted to change thrust characteristics. In FIG. 25, the coolant flow rate is low, which results in exhaust gas 258 remaining in contact with the primary thrust surface 232 for a longer period and prevents overexpansion of exhaust gas 258, which is advantageous during lower operating speeds of the flight vehicle 102. FIG. 26 illustrates a coolant rate that is high, which is advantageous during higher operating speeds of the flight vehicle 102. More specifically, during high speed operation, the coolant primarily provides cooling to the nozzle assembly 200, as overexpansion of the exhaust gas 258 is of less concern.

In the illustrated examples, a controller 260 is provided to control operation of the nozzle assembly 200. For example, the controller 260 is operably coupled to the coolant regulator 253 to control the coolant flow rate as desired. While the specific hardware implementation of the controller 260 is subject to design choices, one particular example includes one or more processors coupled with a current driver. The one or more processors may include any electronic circuits and/or optical circuits that are able to perform the functions described herein. For example, the processor(s) may perform any functionality described herein for controller 260. The processor(s) may include one or more Central Processing Units (CPU), microprocessors, Digital Signal Processors (DSPs), Application-specific Integrated Circuits (ASICs), Programmable Logic Devices (PLD), control circuitry, etc. Some examples of processors include INTEL® CORE™ processors, Advanced Reduced Instruction Set Computing (RISC) Machines (ARM®) processors, etc.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

According to a first example of the subject matter disclosed herein, a turbine engine for a high speed flight vehicle comprises an inlet air duct having an upstream end for receiving ambient air and a downstream end, the inlet air duct directing a duct air flow from the upstream end to the downstream end, a fan disposed in the inlet air duct, an engine core disposed in the inlet air duct and operably coupled to the fan, the engine core being disposed downstream of the fan and including a core housing, through which passes a core air flow portion of the duct air flow, and an afterburner disposed in the inlet air duct and downstream of the engine core. A heat exchanger is disposed in the inlet air duct.

According to a second example of the subject matter disclosed herein, which second example encompasses the first example above, the heat exchanger is positioned upstream of the fan, and the heat exchanger is configured to absorb heat from an entirety of the duct air flow.

According to a third example of the subject matter disclosed herein, which third example encompasses the first example above, the heat exchanger is positioned upstream of the fan, and the heat exchanger is configured to absorb heat from the core air flow portion of the duct air flow.

According to a fourth example of the subject matter disclosed herein, which fourth example encompasses the first example above, the heat exchanger is positioned between the fan and the engine core, and the heat exchanger is configured to absorb heat from the core air flow portion of the duct air flow.

According to a fifth example of the subject matter disclosed herein, which fifth example encompasses the first example above, the engine core further comprises a low pressure compressor disposed in the core housing and a high pressure compressor disposed in the core housing and located downstream of the low pressure compressor, the heat exchanger is positioned between the low pressure compressor and the high pressure compressor, and the heat exchanger is configured to absorb heat from the core air flow portion of the duct air flow.

According to a sixth example of the subject matter disclosed herein, which sixth example encompasses the first example above, the heat exchanger further comprises at least one spot-cooling heat exchanger disposed within the core housing.

According to a seventh example of the subject matter disclosed herein, which seventh example encompasses the sixth example above, the inlet air duct includes an afterburner liner surrounding the afterburner, and the heat exchanger further comprises a liner cooler positioned upstream of and in longitudinal alignment with the afterburner liner.

According to an eighth example of the subject matter disclosed herein, which eighth example encompasses any one of the first through seventh examples above, a nozzle assembly is provided for a flight vehicle having an engine, the nozzle assembly comprising a cowl in fluidic communication with the engine, the cowl including a cowl internal surface defining a cowl orifice, a plug defining a primary thrust surface, wherein the plug is supported relative to the cowl so that a portion of the primary thrust surface is disposed within the cowl orifice, wherein the primary thrust surface of the plug and the cowl internal surface are spaced to define a throat, and an actuator coupled to at least one of the cowl or the plug, the actuator configured to generate relative movement between the cowl and the plug, thereby to modify the throat.

According to a ninth example of the subject matter disclosed herein, which ninth example encompasses the eighth example above, the nozzle assembly further comprises a cooling system having a source of coolant thermally coupled to the primary thrust surface of the plug.

According to a tenth example of the subject matter disclosed herein, which tenth example encompasses the ninth example above, the primary thrust surface is formed by a plug wall having a plug wall interior surface and a plug wall exterior surface, wherein the plug wall exterior surface forms the primary thrust surface of the plug.

According to an eleventh example of the subject matter disclosed herein, which eleventh example encompasses the tenth example above, the plug wall is impervious, and the cooling system directs coolant onto the plug wall interior surface.

According to a twelfth example of the subject matter disclosed herein, which twelfth example encompasses the tenth example above, the plug wall defines perforations extending from the plug wall interior surface to the plug wall exterior surface, and in which the cooling system directs coolant to the plug wall interior surface, through the perforations, and onto the plug wall exterior surface.

According to a thirteenth example of the subject matter disclosed herein, which thirteenth example encompasses the twelfth example above, the cooling system comprises a coolant regulator configured to adjust a coolant flow rate at which coolant is supplied to the plug from the coolant source.

According to a fourteenth example of the subject matter disclosed herein, which fourteenth example encompasses the twelfth example above, the perforations comprise rectilinear perforation profiles.

According to a fifteenth example of the subject matter disclosed herein, which fifteenth example encompasses the twelfth example above, the perforations comprise curvilinear perforation profiles.

According to a sixteenth example of the subject matter disclosed herein, which sixteenth example encompasses the twelfth example above, the perforations comprise both rectilinear perforation profiles and curvilinear perforation profiles.

According to a seventeenth example of the subject matter disclosed herein, which seventeenth example encompasses the ninth example above, the coolant source comprises bypass air.

According to an eighteenth example of the subject matter disclosed herein, which eighteenth example encompasses the eighth example above, the plug is stationary and the cowl is movable relative to the plug.

According to a nineteenth example of the subject matter disclosed herein, which nineteenth example encompasses the eighth example above, the cowl is stationary and the plug is movable relative to the cowl.

According to a twentieth example of the subject matter disclosed herein, which twentieth example encompasses the eighth example above, both the cowl and the plug are movable.

According to a twenty-first example of the subject matter disclosed herein, which twenty-first example encompasses the eighth example above, the relative movement between the cowl and the plug is translation.

According to a twenty-second example of the subject matter disclosed herein, which twenty-second example encompasses the twenty-first example above, the translation is in a direction that is parallel to a longitudinal axis of an airframe of the flight vehicle.

According to a twenty-third example of the subject matter disclosed herein, which twenty-third example encompasses the twenty-first example above, the translation is in a direction that is perpendicular to a longitudinal axis of an airframe of the flight vehicle.

According to a twenty-fourth example of the subject matter disclosed herein, which twenty-fourth example encompasses the twenty-first example above, the translation is at an angle relative to a longitudinal axis of an airframe of the flight vehicle.

According to a twenty-fifth example of the subject matter disclosed herein, which twenty-fifth example encompasses the eighth example above, the relative movement between the cowl and the plug is angular rotation.

According to a twenty-sixth example of the subject matter disclosed herein, which twenty-sixth example encompasses the eighth example above, the primary thrust surface of the plug comprises a partial-axisymmetric shape.

According to a twenty-seventh example of the subject matter disclosed herein, which twenty-seventh example encompasses the twenty-sixth example above, the plug further comprises a plug base coupled to an airframe of the flight vehicle.

According to a twenty-eighth example of the subject matter disclosed herein, which twenty-eighth example encompasses the twenty-sixth example above, the partial-axisymmetric shape is a partial ellipsoid shape.

According to a twenty-ninth example of the subject matter disclosed herein, which twenty-ninth example encompasses the eighth example above, the primary thrust surface of the plug comprises a partial prism shape.

According to a thirtieth example of the subject matter disclosed herein, which thirtieth example encompasses any one of the first through twenty-ninth examples above, a flight vehicle, comprises an airframe, an inlet duct coupled to the airframe, an engine disposed in the inlet duct, and a nozzle assembly disposed downstream of the engine. The nozzle assembly comprises a cowl in fluidic communication with the engine, the cowl including a cowl internal surface defining a cowl orifice, and a plug defining a primary thrust surface, wherein the plug is supported by the airframe relative to the cowl so that a portion of the primary thrust surface is disposed within the cowl orifice, wherein the primary thrust surface of the plug and the cowl internal surface are spaced to define a throat. An actuator is coupled to at least one of the cowl or the plug, and is configured to generate relative movement between the cowl and the plug, thereby to modify the throat.

According to a thirty-first example of the subject matter disclosed herein, which thirty-first example encompasses any one of the first through thirtieth examples above, a nozzle assembly is provided for a flight vehicle having an engine and an airframe. The nozzle assembly comprises a cowl in fluidic communication with the engine, the cowl including a cowl internal surface defining a cowl orifice. The nozzle assembly further comprises a plug defining a primary thrust surface, wherein the plug is supported by the airframe relative to the cowl so that a portion of the primary thrust surface is disposed within the cowl orifice, wherein the primary thrust surface of the plug and the cowl internal surface are spaced to define a throat, the primary thrust surface comprising a partial axi-symmetrical shape. An actuator is coupled to at least one of the cowl or the plug, the actuator configured to generate relative movement between the cowl and the plug, thereby to modify the throat, and a coolant source is thermally coupled to the primary thrust surface of the plug.

According to a thirty-second example of the subject matter disclosed herein, which thirty-second example encompasses any one of the first through thirty-first examples above, a method of providing thrust to a flight vehicle that has an engine and an airframe comprises providing a nozzle assembly. The nozzle assembly comprises a cowl in fluidic communication with the engine, the cowl including a cowl internal surface defining a cowl orifice, and a plug defining a primary thrust surface, wherein the plug is supported by the airframe relative to the cowl so that a portion of the primary thrust surface is disposed within the cowl orifice, wherein the primary thrust surface of the plug and the cowl internal surface are spaced to define a throat. The method further comprises generating relative movement between the cowl and the plug, thereby to modify the throat.

According to a thirty-third example of the subject matter disclosed herein, which thirty-third example encompasses the thirty-second example above, the method further comprises cooling the primary thrust surface of the plug.

According to a thirty-fourth example of the subject matter disclosed herein, which thirty-fourth example encompasses the thirty-second example above, cooling the primary thrust surface of the plug comprises providing coolant to a plug wall exterior surface.

According to a thirty-fifth example of the subject matter disclosed herein, which thirty-fifth example encompasses the thirty-fourth example above, the method further comprises controlling a flow rate of the coolant to the plug wall exterior surface so that the coolant is injected into exhaust gas flow from the nozzle assembly.

Although specific examples were described herein, the scope is not limited to those specific examples. Rather, the scope is defined by the following claims and any equivalents thereof.

What is claimed is:

1. A turbine engine for a high speed flight vehicle, the turbine engine comprising:
an inlet air duct having an upstream end for receiving ambient air and a downstream end, the inlet air duct directing a duct air flow from the upstream end to the downstream end;
a fan disposed in the inlet air duct;
an engine core disposed in the inlet air duct and operably coupled to the fan, the engine core being disposed downstream of the fan and including a core housing, through which passes a core air flow portion of the duct air flow;
an afterburner disposed in the inlet air duct and downstream of the engine core; and
a heat exchanger disposed in the inlet air duct.

2. The turbine engine of claim 1, in which:
the heat exchanger is positioned upstream of the fan; and
the heat exchanger is configured to absorb heat from an entirety of the duct air flow.

3. The turbine engine of claim 1, in which:
the heat exchanger is positioned upstream of the fan; and
the heat exchanger is configured to absorb heat from the core air flow portion of the duct air flow.

4. The turbine engine of claim 1, in which:
the heat exchanger is positioned between the fan and the engine core; and
the heat exchanger is configured to absorb heat from the core air flow portion of the duct air flow.

5. The turbine engine of claim 1, in which:
the engine core further comprises:
a low pressure compressor disposed in the core housing; and
a high pressure compressor disposed in the core housing and located downstream of the low pressure compressor;
the heat exchanger is positioned between the low pressure compressor and the high pressure compressor; and
the heat exchanger is configured to absorb heat from the core air flow portion of the duct air flow.

6. The turbine engine of claim 1, in which the heat exchanger further comprises at least one spot-cooling heat exchanger disposed within the core housing.

7. The turbine engine of claim 6, in which:
the inlet air duct includes an afterburner liner surrounding the afterburner; and
the heat exchanger further comprises a liner cooler positioned upstream of and in longitudinal alignment with the afterburner liner.

8. A nozzle assembly for a flight vehicle having an engine, the nozzle assembly comprising:
a cowl in fluidic communication with the engine, the cowl including a cowl internal surface defining a cowl orifice;
a plug defining a primary thrust surface, wherein the plug is supported relative to the cowl so that a portion of the primary thrust surface is disposed within the cowl orifice, wherein the primary thrust surface of the plug and the cowl internal surface are spaced to define a throat; and
an actuator coupled to at least one of the cowl or the plug, the actuator configured to generate relative movement between the cowl and the plug, thereby to modify the throat.

9. The nozzle assembly of claim 8, further comprising a cooling system having a source of coolant thermally coupled to the primary thrust surface of the plug.

10. The nozzle assembly of claim 9, in which the primary thrust surface is formed by a plug wall having a plug wall interior surface and a plug wall exterior surface, wherein the plug wall exterior surface forms the primary thrust surface of the plug.

11. The nozzle assembly of claim 10, in which the plug wall is impervious, and the cooling system directs coolant onto the plug wall interior surface.

12. The nozzle assembly of claim 10, in which the plug wall defines perforations extending from the plug wall interior surface to the plug wall exterior surface, and in which the cooling system directs coolant to the plug wall interior surface, through the perforations, and onto the plug wall exterior surface.

13. The nozzle assembly of claim 12, in which the cooling system comprises a coolant regulator configured to adjust a coolant flow rate at which coolant is supplied to the plug from the coolant source.

14. The nozzle assembly of claim 9, in which the coolant source comprises bypass air.

15. The nozzle assembly of claim 8, in which the plug is stationary and the cowl is movable relative to the plug.

16. The nozzle assembly of claim 8, in which:
the plug further comprises a plug base coupled to an airframe of the flight vehicle;
the plug base extends around a periphery of the primary thrust surface; and
the primary thrust surface comprises a partial-axisymmetric shape.

17. A method of providing thrust to a flight vehicle having an engine and an airframe, the method comprising:
providing a nozzle assembly, the nozzle assembly comprising:
a cowl in fluidic communication with the engine, the cowl including a cowl internal surface defining a cowl orifice; and
a plug defining a primary thrust surface, wherein the plug is supported by the airframe relative to the cowl so that a portion of the primary thrust surface is disposed within the cowl orifice, wherein the primary thrust surface of the plug and the cowl internal surface are spaced to define a throat; and
generating relative movement between the cowl and the plug, thereby to modify the throat.

18. The method of claim 17, further comprising cooling the primary thrust surface of the plug.

19. The method of claim 17, wherein cooling the primary thrust surface of the plug comprises providing coolant to a plug wall exterior surface.

20. The method of claim 19, further comprising controlling a flow rate of the coolant to the plug wall exterior surface so that the coolant is injected into exhaust gas flow from the nozzle assembly.
